(19) United States
(12) Patent Application Publication
(10) Pub. No.: US 2020/0071975 A1
(43) Pub. Date: Mar. 5, 2020

(54) DOOR RESTRAINT AND MODIFIED EYE BOLT

(71) Applicant: Larry Ross Consultants, Rio Grande, NJ (US)

(72) Inventor: Larry J. ROSS, Rio Grande, NJ (US)

(21) Appl. No.: 16/555,175

(22) Filed: Aug. 29, 2019

Related U.S. Application Data
(60) Provisional application No. 62/822,116, filed on Mar. 22, 2019.
(60) Provisional application No. 62/791,386, filed on Jan. 11, 2019.
(60) Provisional application No. 62/724,900, filed on Aug. 30, 2018.

(51) Int. Cl. E05C 19/18; E05B 9/00; F16B 45/02

(52) U.S. Cl. CPC E05C 19/184; F16B 45/02; E05B 9/00

(57) ABSTRACT

Door restraints with a cable, wire clip or bolt and modified eye bolt and methods for use for preventing opening of a door with these door restraints are provided.

This patent application claims the benefit of priority from U.S. Provisional Application Ser. No. 62/822,116 filed Mar. 22, 2019, U.S. Provisional Application Ser. No. 62/791,386, filed Jan. 11, 2019 and U.S. Provisional Application Ser. No. 62/724,900 filed Aug. 30, 2018, the contents of each of which is herein incorporated by reference in its entirety.

### FIELD

The present invention relates to a door restraint with a cable, bolt and eye bolt for preventing opening of a door. The present invention also relates to a modified eyebolt with an opening and hinged safety latch at its opening.

### BACKGROUND

With the alarming rise in school shootings, various door restraint devices have been disclosed and implemented to prevent entry by intruders to, for example, school classrooms.

For example, intercoms, commonly installed in every classroom of a school building to enable easier communication between classrooms and the main office, are often install on the outside of main entrances along with with video surveillance equipment to help the office better understand whether an individual requesting access to the school building should be permitted access. Security measures such as this help school staff prevent potential danger before it even reaches the door.

Classrooms in schools are also being equipped with what are referred to as “intruder locks”. Such locks permit a teacher to secure their classroom door from the inside, thereby preventing access to unwanted guests or, in an emergency situation, an intruder. While intruder locks are considered to be heavy duty, intruders can potentially still access the room either by breaking an adjacent window and unlocking the door themselves or by shooting the lock.

Door lockdowns which anchor the door to the floor have also been disclosed. These barricades can be activated quickly by the teacher and are able to withstand a high level of force.

Electronic access control is one of the more advanced security measures available to schools today. While costly, more and more schools are beginning to implement electronic access control systems to more quickly order lockdowns in the event of an emergency. In most cases, these control systems can be programmed and implemented from any device with Internet access, thus allowing school staff members to either limit or permit access to certain parts of the building where doors are equipped with such technology. Such systems can also be programmed to limit building access to non-students during peak drop off and pick up times.

In addition, exit bars, also referred to as panic bars “panic bars,” are being installed on the interior of the door and work to keep the door locked from the outside, but permit easy access when exiting from the inside. In the event of an active shooter situation, exit bars permit a fast and safe exit from a building, and since the doors open toward the outside, exit bars work to prevent any sort of trampling effect. Some exit bars can also be controlled via a control module that will activate locking and unlocking actions.

There is a need for cost effective, easy to install door restraints with adequate strength and a design which prevents intruder access through the door.

### SUMMARY

An aspect of the present invention relates to a door restraint.

The door restraint comprises a wire cable or rope with a first end and second end. The first end of the wire cable or rope is configured in a loop. In one nonlimiting embodiment, a slidable sleeve and cap are placed on the wire cable or rope to form the loop.

In one nonlimiting embodiment, this loop is sized for placement over a door knob of a door. Once placed over the door knob, the loop can be tightened by sliding of the sleeve.

In another nonlimiting embodiment, the loop is sized for fixing the cable to a U-shaped utility hook. In this nonlimiting embodiment, the U-shaped utility hook may be mounted to a plate which is fixed to a door. In one nonlimiting embodiment, a housing means with a removable cover capable of fitting the coiled cable fixed to the U-shaped utility hook inside the housing means surrounds the plate.

The door restraint further comprises a wire clip or bolt which is fitted to the second end of the wire cable or rope. In one nonlimiting embodiment, the bolt comprises lock nuts to prevent any slippage.

The door restraint further comprises an eye bolt. The eye bolt is modified to comprise an opening so that the wire cable can slide into the eye of the eye bolt. In one nonlimiting embodiment, the eyebolt is modified to comprise a hinged safety latch at the opening. In one nonlimiting embodiment, the eye bolt may be screwed into the wall at a distance from the door knob so that the second end of the steel cable can be slid into the eyebolt at its opening with the bolt on the steel cable being directly adjacent to the eyebolt on the side opposite to the door knob thereby preventing the door from opening. In another nonlimiting embodiment, the eyebolt is screwed into the floor in front of a wall parallel with the door.

Another aspect of the present invention relates to methods for preventing a door from opening.

In one nonlimiting embodiment, the method comprises placing the loop at the first end of the cable of the door restraint around the door knob of a door and sliding the sleeve to tighten the loop around the knob. The method further comprises sliding the second end of the cable into the eye bolt on the wall so that the wire clip or bolt on the cable is adjacent to the eyebolt on the side of the eyebolt opposite the door knob, thereby preventing the door from opening.

In another nonlimiting embodiment, the method comprises removing the cover from a housing means with a coiled cable fixed to a U-shaped utility hook mounted to the door, uncoiling the cable and sliding the second end of the cable into the eyebolt in the floor so that the wire clip or bolt on the cable is adjacent to the eyebolt on the side of the eyebolt opposite the door, thereby preventing the door from opening.

Yet another aspect of the present invention relates to an eyebolt modified to comprise an opening and a hinged safety latch at the opening.

### BRIEF DESCRIPTION OF THE FIGURES

FIG. 1 provides a diagram of one nonlimiting embodiment of a door restraint of the present invention.

FIGS. 2A and 2B provide a closer view of the nonlimiting embodiment of door restraint depicted in FIG. 1 showing the first end of the cable of the door restraint as it is placed over the door knob (FIG. 2A) and tightened by sliding of the sleeve toward the knob (FIG. 2B).

FIGS. 3A and 3B provide a closer view of the second end of the cable, bolt and eye bolt of the nonlimiting embodiment of door restraint depicted in FIG. 1 before (FIG. 3A) and after (FIG. 3B) the cable is slid into the eye bolt.

FIG. 4 provides a diagram of an eyebolt modified to comprise a hinged safety latch at the opening.

FIG. 5 provides a diagram of the nonlimiting embodiment of door restraint of FIG. 1 preventing opening of a door.

FIGS. 6A and 6B provide diagrams of another nonlimiting embodiment of a door restraint of the present invention.

FIG. 7 is a photograph showing the inside of the housing means with the cover removed and the cable fixed to the U-shaped utility hook coiled inside the housing means.

### DETAILED DESCRIPTION

The present invention relates to door restraints and methods for use of these restraints to prevent opening of the door.

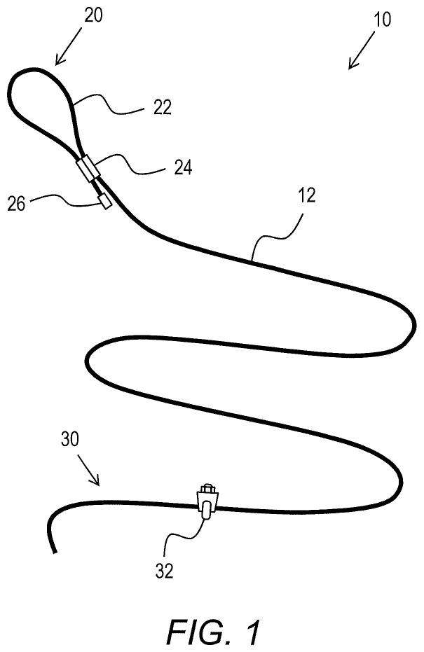

In one nonlimiting embodiment, as depicted in FIG. 1, the door restraint 10 comprises a cable or rope 12 with a first end 20 and a second end 30. In one nonlimiting embodiment, the cable or rope is a wire cable or rope. In one nonlimiting embodiment, the cable or rope is steel cable or rope.

As shown in FIG. 1, the first end 20 of the cable or rope is configured in a loop 22. In one nonlimiting embodiment, a slidable sleeve 24 and cap 26 are placed on the cable or rope 12 to form the loop 22.

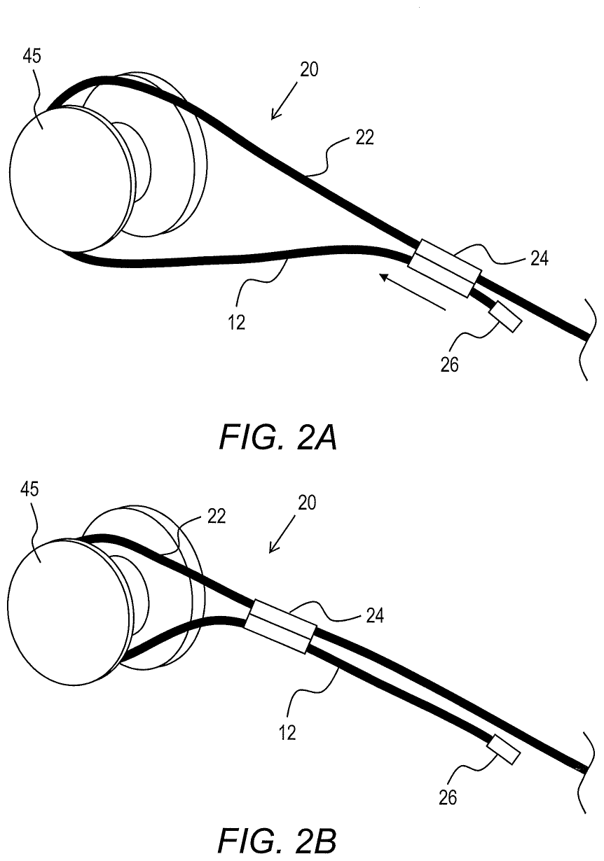

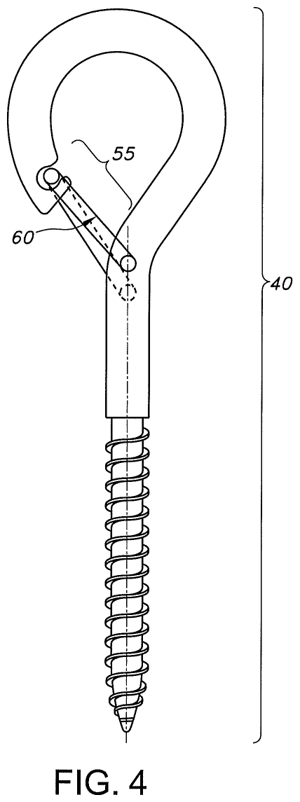

As shown in FIGS. 2A and 2B as well as FIG. 4, in this nonlimiting embodiment, the loop 22 is sized for placement over a door knob 45 of a door 50. As will be understood by the skilled artisan upon reading this disclosure, the loop may be adjusted for fitting over various shaped door knobs or levers and the invention is in no way restricted to a round door knob as depicted in FIGS. 2 and 4. Once placed over the door knob 45 as depicted in FIG. 2A, the loop can be tightened by sliding of the sleeve 24 on the cable 12 toward the door knob.

The door restraint 10 further comprises a wire clip or bolt 32 which is fitted to the second end 30 of the cable or rope 12. In one nonlimiting embodiment, the bolt 32 comprises lock nuts to prevent any slippage.

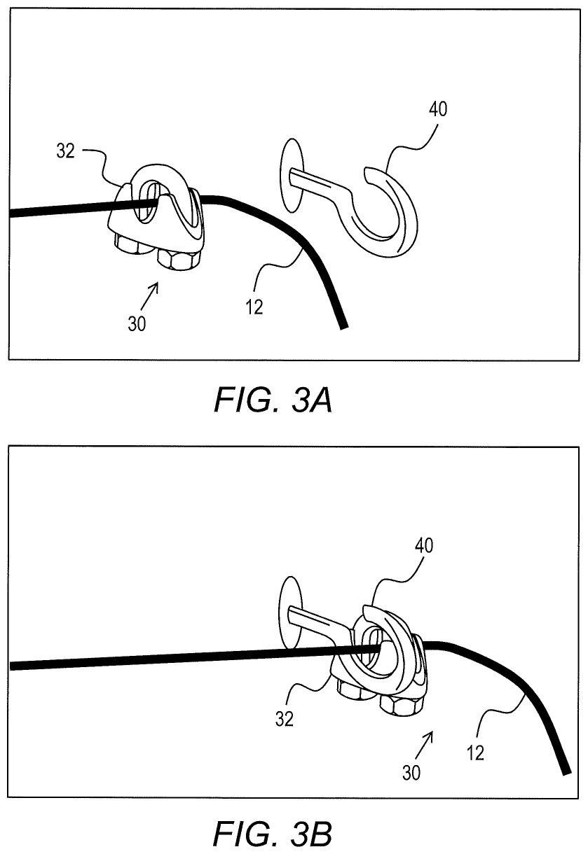

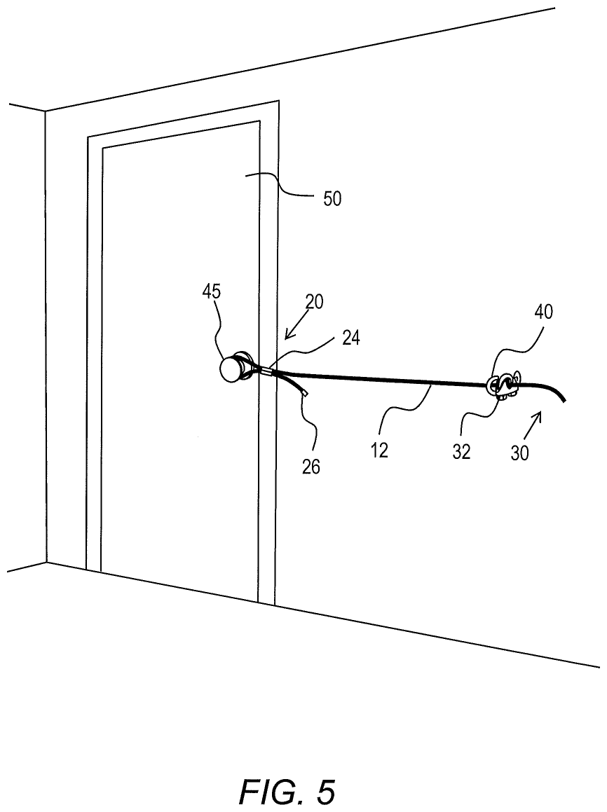

As shown in FIGS. 3A and 3B, FIG. 4 and FIG. 5, in this nonlimiting embodiment, the door restraint 10 further comprises an eye bolt 40 which is screwed into a wall parallel with the door 50. In one nonlimiting embodiment, the eye bolt is screwed into a stud in the wall. As shown in FIG. 3B, the eye bolt 40 is configured or modified so that the cable 12 can slide into the eye of the eye bolt 40. In one embodiment, a portion of the eyebolt is cut so that the cable can slide into the eye bolt via an opening 55. In one nonlimiting embodiment, as shown in FIG. 4, the eyebolt 40 is modified to comprise a hinged safety latch 60 at the opening 55. As shown in FIG. 5, the eye bolt 40 is screwed into a wall in which the door 50 is contained at a distance from the door knob 45 so that the second end 30 of the cable can be slid into the eyebolt 40 with the bolt 32 on the cable 12 being directly adjacent to the eyebolt 40 on the side opposite to the door knob 45 thereby preventing the door 50 from opening.

When not engaged, it is preferred that in this nonlimiting embodiment, the door restraint be stored visibly adjacent to the door on the eye bolt or on a separate hook for easy, quick access.

As shown in FIG. 5, when needed, in this nonlimiting embodiment, the door restraint 10 can quickly be used to prevent the door from opening by placing the loop 22 at the first end 20 of the cable 12 of the door restraint 10 around the door knob 45 of the door 50 and sliding the sleeve 24 to tighten the loop 22 around the knob. The second end 30 of the cable 12 can then be slid into the eye bolt 40 on the wall so that the bolt 32 on the second end 30 of the cable 12 is adjacent to the eye bolt 40 on the side of the eye bolt 40 opposite the door knob 45, thereby preventing the door 50 from opening. The door restraint can also be quickly released simply by sliding the second end 30 of the cable 12 out of the eye bolt 40. Further, the door restraint can be easily and cost effectively installed simply by screwing of the eye bolt 40 into the wall.

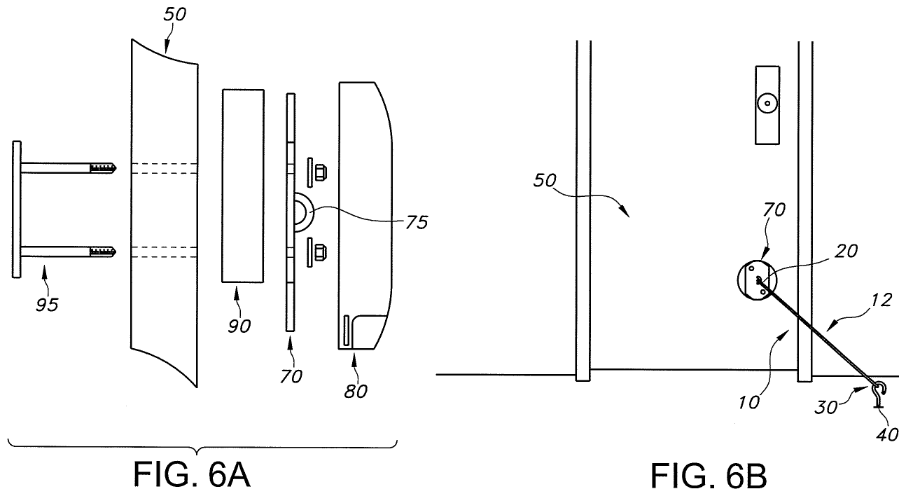

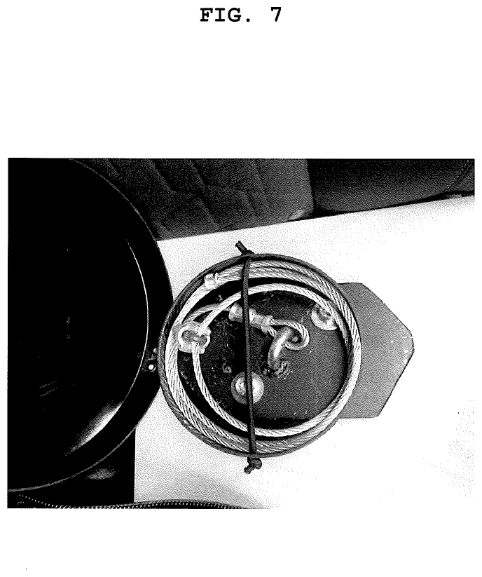

Another nonlimiting embodiment of a door restraint 10 of the present invention is depicted in FIGS. 6A, 6B and 7. In this nonlimiting embodiment, the loop 22 at the first end 20 of the cable is sized for fixing the cable 12 to a U-shaped utility hook 75. In this nonlimiting embodiment, the U-shaped utility hook may be mounted to a plate 70 which is fixed to a door 50. In one nonlimiting embodiment, the plate 70 is fixed to the door 50 via a backing plate 95 on the opposite side of the door. In one nonlimiting embodiment, a housing means with a removable cover 80 capable of fitting the coiled cable 12 fixed to the U-shaped utility hook 75 inside surrounds the plate 70.

The door restraint further comprises a wire clip or bolt which is fitted to the second end 30 of the wire cable or rope 12. In one nonlimiting embodiment, the bolt comprises lock nuts to prevent any slippage.

This nonlimiting embodiment of door restraint also further comprises an eye bolt 40 modified to comprise an opening so that the wire cable can slide into the eye of the eye bolt. In one nonlimiting embodiment, the eyebolt is modified to comprise a hinged safety latch at the opening. In this nonlimiting embodiment, the eyebolt 40 is screwed into the floor in front of a wall parallel with the door.

As shown in FIG. 6B, when needed, in this nonlimiting embodiment, the door restraint 10 can quickly be used to prevent the door from opening by sliding the second end 30 of the cable 12 of the door restraint into the eyebolt 40 in the floor so that the wire clip or bolt 32 on the cable 12 is adjacent to the eyebolt 40 on the side of the eyebolt opposite the door, thereby preventing the door from opening. In one nonlimiting embodiment, the method for preventing the door from opening comprises removing the cover from the housing means 80 with the coiled cable 12 fixed to the U-shaped utility hook 75 mounted to the door, uncoiling the cable and sliding the second end 30 of the cable into the eyebolt 40 in the floor so that the wire clip or bolt 32 on the cable is adjacent to the eyebolt 40 on the side of the eyebolt 40 opposite the door, thereby preventing the door from opening.

The present invention also relates to an eyebolt modified to comprise an opening and a safety latch at its opening. A nonlimiting embodiment of the modified eye bolt is depicted in FIG. 4. While there are a multitude of uses for the modified eye bolt, in one nonlimiting embodiment, the modified eye bolt is used in the door restraint as described herein.

What is claimed is:

1. A door restraint comprising:
(a) a cable with a first end and a second end, wherein said first end is configured in a loop via a slidable sleeve and cap for placement and temporary tightening of the loop of the cable around a door knob of a door by sliding of the sleeve,
(b) a wire clip or bolt fitted to the second end of the cable; and
(c) an eye bolt which fits the wire cable which is screwed into a wall parallel with the door and at a distance from the door knob so that the second end of the cable can be slid into the eye bolt so that the bolt on the cable is adjacent to the eye bolt on a side opposite to the door knob, thereby preventing the door from opening.

2. The door restraint of claim 1 wherein the bolt comprises lock nuts.

3. The door restraint of claim 1 wherein the cable comprises wire.

4. The door restraint of claim 1 wherein the cable comprises steel.

5. The door restraint of claim 1 wherein the eye bolt is screwed into a stud in the wall.

6. The door restraint of claim 1 wherein the eye bolt is modified with an opening so that the wire cable can slide into the eye of the eye bolt.

7. The door restraint of claim 6 wherein the eyebolt is modified to comprise a hinged safety latch at the opening.

8. An eyebolt modified to comprise an opening and a hinged safety latch at the opening.

9. A method of preventing a door from opening, said method comprising:
placing the loop at the first end of the cable of the door restraint of claim 1 around a door knob of a door;
sliding the sleeve to tighten the loop around the knob; and sliding the second end of the cable into the eye bolt on the wall so that the wire clip or bolt on the cable is adjacent to the eyebolt on the side of the eyebolt opposite the door knob, thereby preventing the door from opening.

10. A door restraint comprising:
(a) a cable with a first end and a second end, wherein said first end is configured in a loop sized for fixing the cable to a U-shaped utility hook;
(b) a U-shaped utility hook mounted to a plate which is fixed to a door;
(c) a wire clip or bolt fitted to the second end of the cable; and
(d) an eye bolt which fits the wire cable which is screwed into a floor in front of a wall parallel with the door so that the second end of the cable can be slid into the eye bolt in the floor, thereby preventing the door from opening.

11. The door restraint of claim 10 further comprising a housing means with a removable cover surrounding the cable fixed to the U-shaped utility hook which houses and covers the cable when coiled.

12. The door restraint of claim 10 wherein the bolt comprises lock nuts.

13. The door restraint of claim 10 wherein the cable comprises wire.

14. The door restraint of claim 10 wherein the cable comprises steel.

15. The door restraint of claim 10 wherein the eye bolt is modified with an opening so that the wire cable can slide into the eye of the eye bolt.

16. The door restraint of claim 15 wherein the eyebolt is modified to comprise a hinged safety latch at the opening.

17. A method of preventing a door from opening, said method comprising sliding the second end of the cable of the door restrain of claim 10 into the eyebolt in the floor so that the wire clip or bolt on the cable is adjacent to the eyebolt on the side of the eyebolt opposite the door, thereby preventing the door from opening.

18. A method of preventing a door from opening, said method comprising:
removing from the door restraint of claim 11 the cover of the housing means with the coiled cable fixed to the U-shaped utility hook mounted to the door;
uncoiling the cable; and
sliding the second end of the cable into the eyebolt in the floor so that the wire clip or bolt on the cable is adjacent to the eyebolt on the side of the eyebolt opposite the door, thereby preventing the door from opening.
